(19) United States
(12) Patent Application Publication
(10) Pub. No.: US 2026/0154387 A1
(43) Pub. Date: Jun. 4, 2026

(54) HIGH ASSURANCE PROTECTED BIOMETRIC FLOW

(71) Applicant: QUALCOMM Incorporated, San Diego, CA (US)

(72) Inventors: Jerome PERRINE, Romanel sur Morges (CH); Pierre-Francois APPIETTO, Châteauneuf-le-Rouge (FR)

(21) Appl. No.: 18/967,467

(22) Filed: Dec. 3, 2024

(51) Int. Cl. G06F 21/32; G06F 21/53; G06F 21/60

(52) U.S. Cl. CPC G06F 21/32; G06F 21/53; G06F 21/606

(57) ABSTRACT

Systems and techniques are provided for biometric security. For instance, a process can include generating, using a first biometric process executing in a trusted execution environment, a biometric template based on received first biometric information; generating a mask using a second biometric process executing in a secure execution environment separate from the trusted execution environment; transmitting the template to the second biometric process; applying the mask, by the second biometric process, to the biometric template to generate a masked template; and storing the masked template in a memory by the second biometric process.

### FIELD

The present disclosure generally relates to secure computing. For example, aspects of the present disclosure relate to systems and techniques for a high assurance protected biometric flow for securing biometric information.

### BACKGROUND

Object authentication and/or verification can be used to authenticate or verify an object. For example, biometric-based authentication methods exist for authenticating people. Biometric-based authentication can be used for various purposes, such as providing access to places and/or electronic devices. Examples of biometric-based authentication include face authentication, fingerprint authentication, voice authentication, among others.

Face authentication, for example, can compare a face of a device user in an input image with known features of the person the user claims to be, in order to authenticate that the user of the device is, in fact, the person. A similar process can be performed for fingerprint authentication, voice authentication, and other biometric-based authentication methods.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing delegated attestation. In one illustrative example, an apparatus for biometric security is provided. The apparatus includes a memory system comprising instructions; and a processor system coupled to the memory system. The processor system is configured to: generate, using a first biometric process executing in a trusted execution environment, a biometric template based on received first biometric information; generate a mask using a second biometric process executing in a secure execution environment separate from the trusted execution environment; apply the mask, by the second biometric process, to the biometric template to generate a masked template; and store the masked template in the memory system by the second biometric process.

As another example, a method for biometric security is provided. The method includes: generating, using a first biometric process executing in a trusted execution environment, a biometric template based on received first biometric information; generating a mask using a second biometric process executing in a secure execution environment separate from the trusted execution environment; applying the mask, by the second biometric process, to the biometric template to generate a masked template; and storing the masked template in a memory by the second biometric process.

In another example, a non-transitory computer-readable medium having stored thereon instructions is provided. The instruction, when executed by at least one processor, cause the at least one processor to: generate, using a first biometric process executing in a trusted execution environment, a biometric template based on received first biometric information; generate a mask using a second biometric process executing in a secure execution environment separate from the trusted execution environment; apply the mask, by the second biometric process, to the biometric template to generate a masked template; and store the masked template in the memory system by the second biometric process.

As another example, an apparatus for biometric security is provided. The apparatus includes: means for generating, using a first biometric process executing in a trusted execution environment, a biometric template based on received first biometric information; means for generating a mask using a second biometric process executing in a secure execution environment separate from the trusted execution environment; means for applying the mask, by the second biometric process, to the biometric template to generate a masked template; and means for storing the masked template in a memory by the second biometric process.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component. In some aspects, the apparatus includes one or more hardware components for secure computing, such as a trusted execution environment (TEE), which may be a secure area in a processor for executing trusted code, and/or a high assurance execution environment (HAEE), which may be a secure execution environment separate from the TEE. In some aspects, the apparatus includes one or more biometric sensors for sensing unique physical characteristics of a person, such as a fingerprint reader, facial recognition, iris scanner, ultrasonic sensor, to other biometric sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware elements including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a diagram illustrating an example wireless device, in accordance with some examples;

FIG. 2 is a flowchart illustrating an example of a general authentication process using a face as biometric data;

FIG. 3 is a diagram illustrating signals and operations for biometric enrollment using a high assurance protected biometric flow, in accordance with aspects of the present disclosure;

FIG. 4 is a diagram illustrating signals and operations for biometric authentication using a high assurance protected biometric flow, in accordance with aspects of the present disclosure;

FIG. 5 is a diagram illustrating signals and operations for biometric authentication using another high assurance protected biometric flow, in accordance with aspects of the present disclosure;

FIG. 6 is a flow diagram of a process for biometric security, in accordance with aspects of the present disclosure; and

FIG. 7 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Biometrics is the science of analyzing physical or behavioral characteristics specific to each individual, in order to be able to authenticate the identity of each individual. Biometric-based authentication methods can be used to authenticate people, such as to provide access to devices, systems, places, or other accessible items. In some cases, biometric-based authentication allows a person to be authenticated based on a set of templates (verifiable data), which are unique to the person. Examples of biometric-based authentication include face authentication, fingerprint authentication, voice authentication, among others. Face authentication, for example, can compare a face of a device user in an input image with known features (e.g., stored in one or more templates) of the person the user claims to be, in order to authenticate that the user of the device is, in fact, the person. A similar process can be performed for fingerprint authentication, voice authentication, and other biometric-based authentication methods.

Biometric-based user authentication systems typically have at least two steps, including an enrollment step and an authentication step (or test step). The enrollment step captures biometric data (e.g., biometric information) and stores representations of the biometric data as a biometric template (e.g., template). The biometric template may be a representation of biometric data for a person that can be stored and matched against to authenticate the person. The template can then be used in the authentication step. For example, the authentication step can determine the similarity of the template against a representation of input biometric data (also referred to as user credentials). The authentication step can use the similarity to determine whether to authenticate the user.

In some cases, biometric systems may be used to authenticate or verify a person, for example, to allow access to a device, area, and/or application. Using face authentication as an example, an input query face image can be compared with stored or enrolled representations of a person's face to determine whether to allow the person access to a device.

In some cases, a device may perform biometric processing (e.g., for a biometric system) using a biometric process execution environment (BPEE). The BPEE may be a process executing in a trusted execution environment (TEE) of the device or component of the device, such as a digital signal processor (DSP). The TEE may be secure area of, for example, a processor that can be used to process and/or store sensitive data in an environment that is segregated from a rich execution environment in which a primary operating system (e.g., user facing operating systems such as Android, iOS, Windows, etc.) and/or applications may be executed. The TEE may be a type of secure execution environment. A secure execution environment may be an isolated processing environment for executing code and the secure execution environment may limit access to certain resources of the device, for example, to maintain security. In contrast, a rich execution environment may be a processing environment for executing code which has access to substantially all of the resources of the devices. However, the templates may be vulnerable to attack as they may be stored in the clear. Additionally, the BPEE may be vulnerable to certain types of attacks.

Systems, apparatuses, electronic devices, methods (also referred to as processes), and computer-readable media (collectively referred to herein as “systems and techniques”) are described herein for biometric security using a high assurance protected biometric flow. In some cases, devices may include a high assurance execution environment (HAEE). This HAEE may be a secure execution environment separate from the TEE and the HAEE may include an added layers of hardware security as compared to the TEE and/or DSP. The HAEE may provide increased security that may be used to enhance security of biometric processing. For example, templates may be masked and encrypted by the HAEE, access to the templates for authentication, use of a timer, and anti-replay counter may be performed in part with the HAEE. The anti-reply counter may be a counter that tracks a number of tries to biometrically authenticate have occurred.

For example, enrollment for biometric security using a high assurance protected biometric flow may include obtaining, based on an enrollment request, first biometric information about a person, such as a fingerprint, handprint, iris scan, face scan, etc. The biometric information may be passed to a first biometric process executing in a trusted execution environment (e.g., BPEE). A biometric process may refer to an executing set of instructions (e.g., software program or hardware implemented) that are related to obtaining, accessing, processing, and/or storing biometric information. The first biometric process may generate a biometric template using the biometric information. The first biometric process may obtain a mask from a second biometric process executing in a separate secure execution environment, such as the HAEE. A mask may be a data structure that indicates which portions of the biometric information may be changed (e.g., bit flipped) and which portions remain unchanged. The mask may be applied to the biometric information by the first biometric process and resulting masked templates sent to the second biometric process. The masked template may be a biometric template to which a mask has been applied to. The mask changes the biometric template, making the masked template unusable for biometric authentication without unmasking the masked template. The second biometric process may encrypt the masked templates and store the encrypted masked templates in a memory, such as a secure memory store.

For authentication, after an authentication request is received, the first biometric process may check an anti-replay counter maintained by the second biometric process to verify that a maximum anti-replay counter value has not been reached. The maximum anti-replay counter value may be arbitrarily defined to a number, typically a single digit number, such as 5. In some cases, the maximum anti-reply counter value may be configurable. If the maximum anti-replay counter value has been reached, then the biometric process may be locked out until a passcode/personal identification number (PIN)/pattern, etc. is provided. If the maximum anti-replay counter value has not been reached, second biometric information may be obtained. In some cases, the first biometric process may send a request for the masked template to the second biometric process. The first biometric process may also request the mask from the second biometric process or the first biometric process may request that the second biometric process mask the second biometric information. The second biometric process may decrypt the masked template and send a memory address to the decrypted masked template to the first biometric process.

In cases where the mask is requested, the second biometric process may send the encrypted mask value to the first biometric process, which may decrypt the mask value and apply the mask value to the second biometric information. The first biometric process may then compare the masked second biometric information to the masked template. After the comparison, the masked second biometric information and masked template may be deleted.

In cases where the first biometric process requests that the second biometric process mask the second biometric information, the first biometric process may send the second biometric information to the second biometric process. The second biometric process may decrypt the mask and apply the mask to the second biometric information. The second biometric process may then send the masked second biometric information to the first biometric process. The first biometric process may then compare the masked second biometric information to the masked template. After the comparison, the masked second biometric information and masked template may be deleted.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a digital signal processor (DSP), a central processing unit (CPU), a graphics processing unit (GPU), any combination thereof, and/or other processing device or component.

Additional aspects of the present disclosure are described in more detail below.

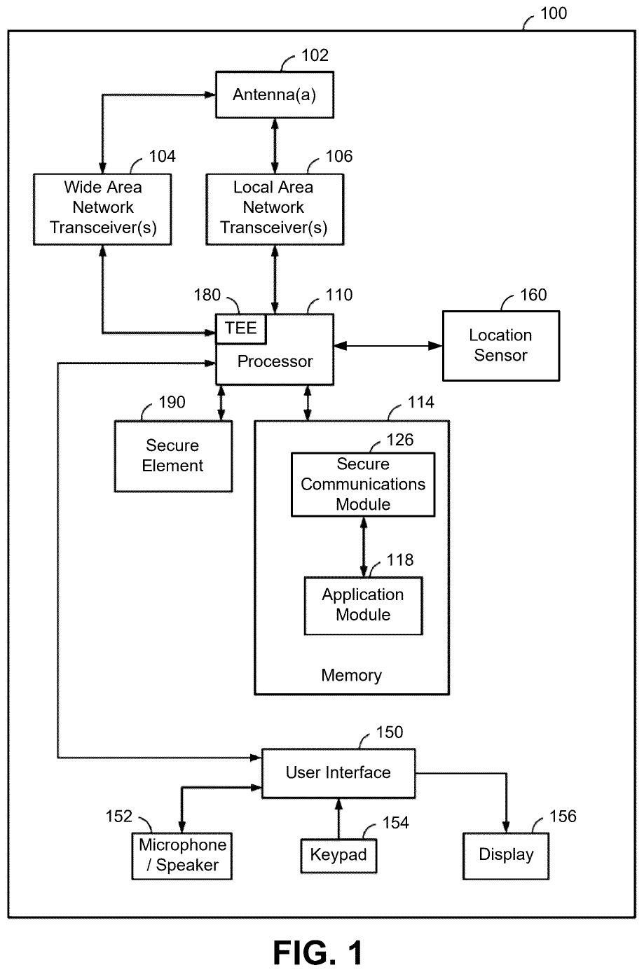

FIG. 1 is a diagram illustrating an example wireless device 100 that can be used to perform the techniques described herein. The wireless device 100 may include a client device such as a user equipment (UE) or other type of device (e.g., a station (STA) configured to communication using a Wi-Fi interface) that may be used by an end-user. For example, the wireless device 100 may include a mobile phone, a vehicle or computing system or device of the vehicle, a router, a tablet computer, a laptop computer, a tracking device, a wearable device (e.g., a smart watch, glasses, etc.), an extended reality (XR) device (e.g., a virtual reality (VR), augmented reality (AR), or mixed reality (MR) device, etc.), an Internet of Things (IoT) device, a access point, a point of sale device, and/or another device that is configured to communicate over a wireless communications network.

As shown, the wireless device 100 may include one or more local area network transceivers 106 that may be connected to one or more antennas 102. The one or more local area network transceivers 106 comprise suitable devices, circuits, hardware, and/or software for communicating with and/or detecting signals to/from a network device, and/or directly with other wireless devices, within a network.

The wireless device 100 may also include, in some implementations, one or more wide area network transceiver(s) 104 that may be connected to the one or more antennas 102. The wide area network transceiver 104 may comprise suitable devices, circuits, hardware, and/or software for communicating with and/or detecting signals from one or more other devices or systems and/or directly with other wireless devices within a network. In some implementations, the wide area network transceiver(s) 104 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 110 may be connected to the local area network transceiver(s) 106 and the wide area network transceiver(s) 104. The processor 110 may include one or more microprocessors, microcontrollers, and/or digital signal processors that provide processing functions, as well as other calculation and control functionality. The processor 110 may be coupled to storage media (e.g., memory) 114 for storing data and software instructions for executing programmed functionality within the mobile device. The memory 114 may be on-board the processor 110 (e.g., within the same IC package), and/or the memory may be external memory to the processor and functionally coupled over a data bus.

In some cases, the processor 110 may be coupled to a location sensor 160. The location sensor 160 may provide information regarding a location of the wireless device 100. In some cases, the location sensor 160 may include a Global Navigation Satellite System (GNSS) receivers or transceivers that are used to determine a location of the wireless device 100. In some cases, the location sensor 160 may estimate a location of the wireless device 100, for example, based on wireless signals received from one or more wireless nodes.

A number of software engines and data tables may reside in memory 114 and may be utilized by the processor 110 in order to manage both communications with remote devices/nodes, perform positioning determination functionality, and/or perform device control functionality. In some embodiments, the memory 114 may include an application engine 118 and a secure communications engine 126. It is to be noted that the functionality of the modules and/or data structures may be combined, separated, and/or be structured in different ways depending upon the implementation of the wireless device 100.

The application engine 118 may include a process running on the processor 110 of the wireless device 100, which may request data from one of the other modules of the wireless device 100. Applications typically run within an upper layer of the software architectures and may be implemented in a rich execution environment of the wireless device 100, and may include indoor navigation applications, shopping applications, financial services applications, social media applications, location aware service applications, etc. The applications of the application engine 118 may make use of access tokens to obtain content from a remote server.

The secure communications engine 126 may be a process configured to manage the storage of and access to the access tokens, encryption keys, attestation information, and the like. The secure communications engine 126 may be executed on a processor component of a trusted execution environment (TEE 180) and/or the secure element 190, where the wireless device 100 includes such components. The functionality of the secure communications engine 126 discussed herein can also be implemented as hardware or a combination of hardware and software. The secure communications engine 126 can be implemented one or more application specific integrated circuits (ASICs), programmable logic devices (PLDs), field programmable gate arrays (FPGAs), or other electronic units designed to perform the functions described herein, or a combination thereof.

The wireless device 100 may further include a user interface 150 providing suitable interface systems, such as a microphone/speaker 152, a keypad 154, and a display 156 that allows user interaction with the wireless device 100. The microphone/speaker 152 provides for voice communication services (e.g., using the wide area network transceiver(s) 104 and/or the local area network transceiver(s) 106). The keypad 154 may comprise suitable buttons for user input. The display 156 may include a suitable display, such as, for example, a backlit LCD display, and may further include a touch screen display for additional user input modes.

The processor 110 may also include a TEE 180. The TEE 180 can be implemented as a secure area of the processor 110 that can be used to process and store sensitive data in an environment that is segregated from the rich execution environment in which the operating system and/or applications (such as those of the application engine 118) may be executed. An example of a TEE may include an ARM TrustZone execution environment, which may execute authorized software known as “trusted application.” The TEE 180 can be configured to execute trusted applications that provide end-to-end security for sensitive data by enforcing confidentiality, integrity, and protection of the sensitive data stored therein. The TEE 180 can be used to store encryption keys, access tokens, and other sensitive data. In some cases, the TEE 180 may also be able to attest to the integrity of certain software executing on the wireless device 100. As used herein attestation is a process by which software executing on the wireless device 100 provides an assertion (e.g., information) to a relying party about the integrity of the wireless device 100. Examples for the assertion may include a hash of the application, a measurement of an operating system kernel, cryptographic function, security software, etc.

The wireless device 100 may include a secure element 190 (also referred to herein as a trusted component). The wireless device 100 may include the secure element 190 in addition to or instead of the TEE 180. The secure element 190 can comprise autonomous and tamper-resistant hardware that can be used to execute secure applications and the confidential data associated with such applications. For example, the secure element 190 may include a high assurance execution environment (e.g., secure processing unit), which may include an added layers of hardware security. The secure element 190 may be a secure execution environment separate from the TEE 180 and the secure element 190 may include more limited computing resources as compared to the TEE 180. The secure element 190 can be used to store encryption keys, access tokens, and other sensitive data. The secure element 190 can comprise a Near Field Communication (NFC) tag, a Subscriber Identity Module (SIM) card, or other type of hardware device that can be used to securely store data. The secure element 190 can be integrated with the hardware of the wireless device 100 in a permanent or semi-permanent fashion or may, in some implementations, be a removable or external component of the wireless device 100 that can be used to securely store data and/or provide a secure execution environment for applications.

In some cases, to help reduce an attack surface against side-channel attacks, some secure applications may execute in a secure processing unit, such as the TEE 180 and/or secure element 190, without knowledge of other components in their operating environment, such as the wide/local area networks, sensors, such as the location sensor 160, and/or certain elements of the user interface, such as the microphone/speaker 152. In some cases, certain elements, such as the keypad 154 and/or display 156, may be needed by a secure application, for example, to provide a password to use a key to encrypt/decrypt data.

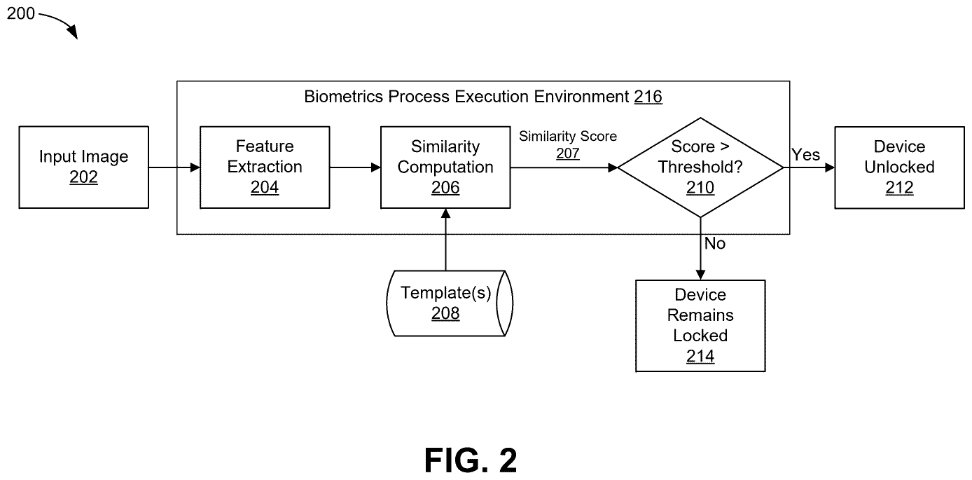

FIG. 2 is a flowchart illustrating an example of a general authentication process 200 using a face as biometric data. As an example, a biometric data 202 of a user attempting to access a device is received. For example, the biometric data 202 can be an image captured by a camera of a wireless device. In some cases, a face detection engine (not shown) can be used to identify the face in the biometric data 202. Of note, while discussed in the context of using a face as biometric data, it should be understood that the general authentication process 200 may be applied to the use of other types of biometric data as well, such as fingerprint identification, palm authentication, iris authentication, etc. In some cases, the biometric data 202 may be another type of biometric information suitable for another type of biometric authentication. For example, for fingerprint authentication, the biometric data 202 may instead be information about a fingerprint. Biometric authentication may be used to verify an identity of a user based on unique biological characteristics of the user.

The biometric data 202 may be processed for feature extraction 204. For example, a feature representation including one or more features of the face can be extracted by a feature extraction engine (not shown) from the biometric data 202 containing the face. In some examples, a cropped portion of the biometric data 202 including the image data within the bounding region identified by the face detection engine is processed for feature extraction. The feature representation of the face can be compared to a face representation (e.g., stored as a biometric template in template storage 208, which may be in a memory of the device) of a person authorized to access the device. In some examples, the template storage 208 can include a database. In some examples, the template storage 208 is part of the same device that is performing biometric authentication (e.g., wireless device 100). As used herein, a biometric template, or template, may be a representation of a biometric feature of a person, such as a representation of the person's face, fingerprint, hand print, iris, finger blood flow patterns, etc.

The biometric templates in the template storage 208 can be generated during an enrollment step, when a person is registering their biometric features for later use during authentication. Each template can be linked internally (e.g., in the template storage 208) to a subject identifier (ID) that is unique to the person being registered. For example, during enrollment (which can also be referred to as registration), an owner of the computing device and/or other user with access to the computing device can input one or more biometric data samples (e.g., an image, a fingerprint sample, a voice sample, or other biometric data). Representative features of the biometric data can be extracted by the feature extraction engine. The representative features of the biometric data can be stored as one or more templates in the template storage 208. For instance, several images can be captured of the owner or user with different poses, positions, facial expressions, lighting conditions, fingers, eyes, palms, and/or other characteristics. Facial features of the different images can be extracted and saved as templates. For instance, a template can be stored for each image, with each template representing the features of each face with its unique pose, position, facial expression, lighting condition, etc. The one or more templates stored in the template storage 208 can be used as a reference point for performing face authentication.

As noted above, the feature extraction engine (not shown) extracts features from the biometric data 202. Any suitable feature extraction technique can be used by the feature extraction engine to extract features from the biometric data (during registration and during the authentication). Various examples of feature extraction techniques that can be used by the feature extraction engine are described in Wang, et al., “Face Feature Extraction: A Complete Review,” IEEE Access, Volume 6, 2018, Pages 6001-6039, which is hereby incorporated by reference in its entirety and for all purposes. One illustrative example of a feature extraction process performed by the feature extraction engine that can generate deep learning features is neural network (e.g., using a deep learning network) based feature extraction. For example, a neural network can be trained using multiple training images to learn distinctive features of various face. Once trained, the trained neural network can then be applied to the biometric data 202. For example, the trained neural network can extract or determine distinctive features of the face.

In some cases, a similarity computation 206 can be made between the feature representation of the user extracted from the biometric data 202 and a feature representation of a template stored in the template storage 208. For example, a representation of the features extracted from the biometric data 202 can be compared to the one or more templates stored in the template storage 208 by a similarity determination engine (not shown). For example, the process 200 can perform a similarity computation 206 to compute the similarity between the biometric data 202 and the one or more templates in the template storage 208. The computed similarity can be used as the similarity score 207 that will be used to make the final authentication decision.

In some cases, the data of the biometric data 202 can also be referred to as query data (e.g., a query face, query fingerprint, etc.). In some cases, the templates can also be referred to as enrolled data (e.g., an enrolled face, enrolled finger, etc.). As noted above, in some examples, the features extracted for a face (or other object or biometric feature) can be represented using a feature vector that represents the face (or other object or biometric feature). For instance, each template can be a feature vector. The representation of the features extracted from the input biometric data can also be a feature vector. Each feature vector can include a number of values representing the extracted features. The values of a feature vector can include any suitable values. In some cases, the values of a feature vector can be floating numbers between −1 and 1, which are normalized feature vector values. The feature vector representing the features of the face from the biometric data 202 can be compared or matched with the one or more feature vectors of the one or more templates to determine a similarity between the feature vectors. For example, a similarity can be determined between the feature vector representing the face in the biometric data 202 and the feature vector of each template, resulting in multiple similarity values.

As noted above, the similarity score 207 can be used to make the final authentication decision. For example, the similarity score 207 can be compared 210 to a similarity threshold. In some examples, the similarity threshold can include a percentage of similarity (e.g., 75%, 80%, 85%, etc. of the features are similar). If the similarity score 207 is greater than the similarity threshold, the device is unlocked at block 212. However, if the similarity score 207 is not greater than the threshold, the device remains locked at block 214.

In some implementations, devices (e.g., mobile devices such as phones) utilizing biometric authentication may implement an unlock timeout period. An unlock timeout period is a period of inactivity on the device (when unlocked), after which the device is automatically locked and a new biometric authentication will need to be performed to unlock the device. In some examples, such devices may also implement a separate screen timeout period. A screen timeout period is a period of inactivity on the device (when the screen or display of the device is active or “on”) after which the screen or display of the device is automatically turned off (e.g., the screen or display is powered off). The device may continue to remain unlocked when the screen or display is turned off.

In some cases, the feature extraction 204, similarity computation 206, and the comparison 210 may be performed within the context of a biometrics process execution environment (BPEE) 216, which may be a process executing in a TEE, such as TEE 180 of FIG. 1. The BPEE may be a process within which biometric information may be processed. In some cases, it may be useful to leverage the increase security offered by the high assurance execution environment (HAEE) of a device in addition to the TEE, for example to help prevent potential replay attacks against the biometric process for enrollment and authentication. In some cases, the HAEE may be a secure execution environment (e.g., on a secure element) which has passed a common certification such as an evaluation assurance level (EAL) and has at least an Evaluation Assurance Level 4 augmented (EAL4+), which is a highest level of security assurance for commercial off-the-shelf (COTS) products. The TEE may be a secure execution environment that has been secured to a lower level, such as EAL2 (e.g., structurally tested) or EAL2+.

In some cases, the HAEE may not be configured for heavy biometric processing, such as performing feature extraction, similarity computations and/or comparisons against a template. In some cases, it may be useful to move some portions of the biometric process into the HAEE to help, for example, further secure processing of biometric information.

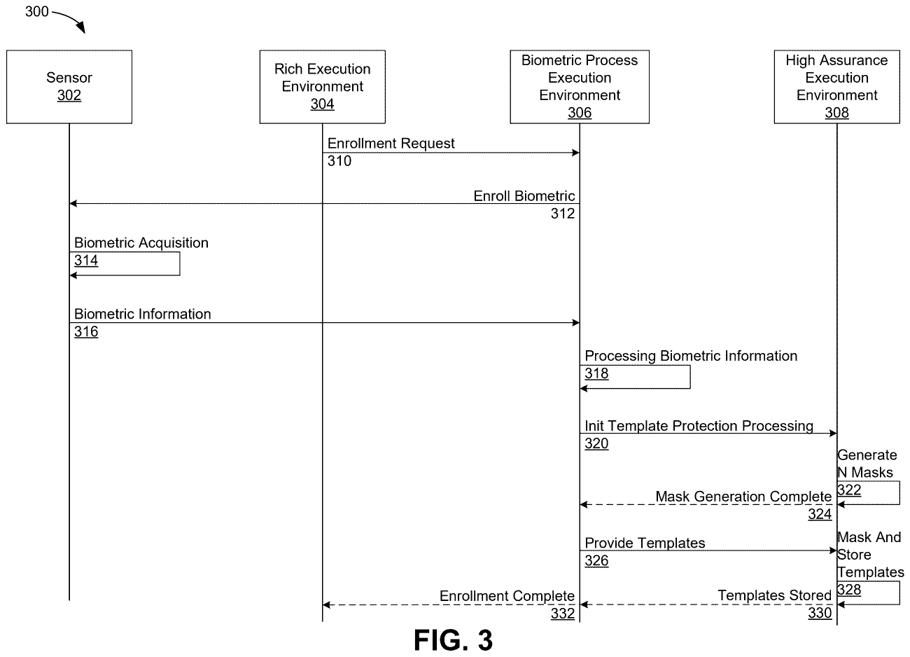

FIG. 3 is a diagram illustrating signals and operations 300 for biometric enrollment using a high assurance protected biometric flow, in accordance with aspects of the present disclosure. FIG. 3 includes a sensor 302 (e.g., biometric sensor), a rich execution environment (REE) 304, a biometric process execution environment (BPEE) 306, and a high assurance execution environment (HAEE) 308. The sensor 302 may be a sensor for capturing biometric information, such as a fingerprint reader, camera, iris scanner, palm print reader, ultrasonic sensor, etc. The REE 304 may be an untrusted execution environment of a device in which a standard operating system (OS) of the device (e.g., Android, iOS, etc.) executes. In some cases, the REE 304 may have access to more features of the device as compared to the BPEE 306 or HAEE 308. The BPEE 306, as discussed above, may execute in a TEE (e.g., TEE 180 of FIG. 1) of the device and the HAEE 308 may execute in a secure element (e.g., secure element 190 of FIG. 1) of the device.

In some cases, an enrollment request 310 may be sent by the REE 304 to the BPEE 306. For example, a user may request, in an application executing on the regular OS of the device, to register (enroll) a biometric, such as a fingerprint for a finger. The BPEE 306 may send an enroll biometric request 312 to the sensor 302 to cause the sensor 302 acquire biometric information 314. For example, the sensor 302 may initiate, in response to the enroll biometric request 312, may sample an environment around the sensor to obtain biometric information 316 (e.g., an image, ultrasonic scan information, infrared data, etc.) that may be used to generate a template. The sensor 302 may send the obtained biometric information 316 to the BPEE 306. The BPEE 306 may process the biometric information 318 to generate a template. In some cases, processing the biometric information 318 may include any type of processing of biometric information for use to identify a user. For example, the BPEE 306 may perform feature extraction (e.g., feature extraction 204 of FIG. 2) on the biometric information 318 to generate a biometric representation (e.g., template) for the user. As another example, the BPEE 306 may process the biometric information by performing live detection and/or another anti-spoofing detection processing of the biometric information 318 to determine whether the biometric information 318 is from a living user (e.g., as opposed to a picture/mask).

The BPEE 306 may transmit an indication to initiate template protection processing 320 by the HAEE 308 and transmit a generated template (or portion thereof) to the HAEE 308. In some cases, multiple templates may be generated by the BPEE 306 and sent to the HAEE 308 for template protection processing. For example, the BPEE 306 may generate N templates and may send the N templates to the HAEE 308 as a part of initiating template protection processing 320. In some cases, the HAEE 308 may generate N masks 322 based on the input templates. For example, the HAEE 308 may generate a mask for each input template. In some cases, the mask may be used to obfuscate the template. As an example, the mask may be associated with a mask key. The mask key may be a pseudo random/random number generated, for example, by the HAEE 308, or the mask key may be derived from a master key of the HAEE 308. The template may be obfuscated by applying the mask value to the values of the template. In some cases, the values of the template may be processed using an involutive function with the mask value. An involutive function may be a function that is its own inverse such that applying the involutive function twice to a value produces the original value. For example, the values of the template may be XORed (exclusive or) with the mask value or processed using another type of involutive function.

After the template masks are generated, the HAEE 308 may indicate to the BPEE 306 that the mask generation is complete 324 and the BPEE 306 may provide the templates 326 (e.g., template masks) to the HAEE 308. The HAEE 308 may mask the templates (e.g., apply the mask to the template), encrypt the masked templates, and store 328 the encrypted masked templates in a storage accessible by the BPEE 306. In some cases, the storage accessible to the BPEE 306 may be a protected storage, such as a secure file store or a secure nonvolatile memory. The HAEE 308 may also initialize an anti-replay counter associated with each template to 1.

After the encrypted masked templates are stored 328, the HAEE 308 may send an indication 330 to the BPEE 306 that the encrypted masked templates were stored. For example, the HAEE 308 may send an acknowledgement message in response to the provided templates 326 to indicate that the encrypted masked templates were stored. The BPEE 306 may then indicate to the REE 304 that the enrollment process is complete 332.

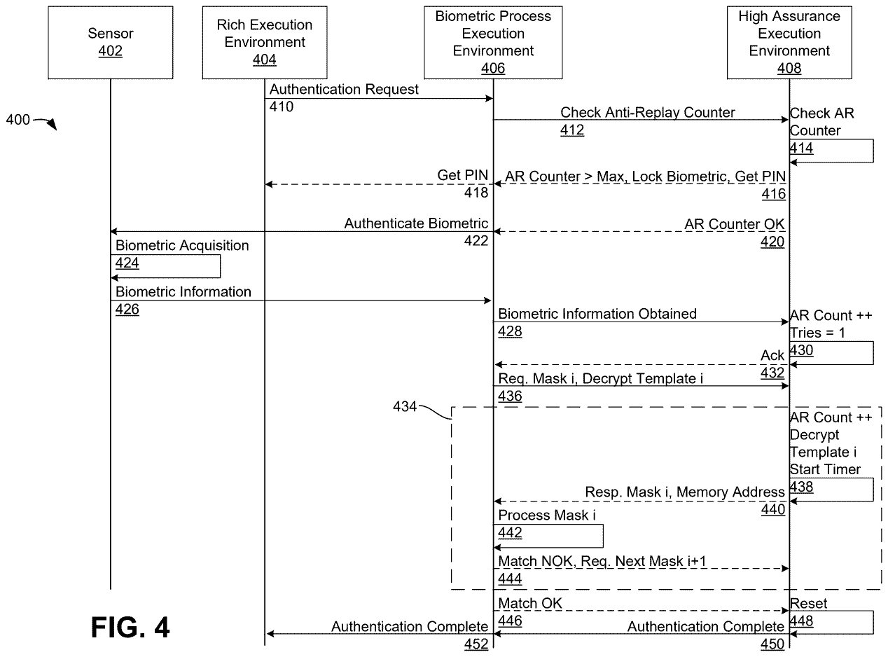

FIG. 4 is a diagram illustrating signals and operations 400 for biometric authentication using a high assurance protected biometric flow, in accordance with aspects of the present disclosure. As in FIG. 3, FIG. 4 includes a sensor 402, an REE 404, a BPEE 406, and a HAEE 408. The sensor 402, REE 404, BPEE 406, and HAEE 408 may be substantially similar to sensor 302, REE 304, BPEE 306, and HAEE 308 of FIG. 3, respectively. The REE 404 may transmit an authentication request 410 to perform biometric authentication to the BPEE 406. For example, a user may be attempting to sign into an account, unlock the device, etc. The BPEE 406 may request a check of the anti-replay counter 412 to the HAEE 408. The HAEE 408 may check the anti-replay counter 414. If the anti-replay counter has exceeded (e.g., exceeded or equal to) a maximum value of the anti-replay counter, the HAEE 408 lock access to the biometric templates and/or the biometric authentication system from the HAEE 408 and may transmit a PIN request 416 (e.g., PIN, pattern, passcode, etc. selected by the user to unlock the device) to the BPEE 406. The BPEE 406 may transmit a request to the REE to obtain the PIN 418 and execution may proceed outside of the biometric authentication flow. In some cases, the maximum value of the anti-replay counter may be a maximum number of attempts to biometrically authenticate before a PIN should be used.

If the anti-replay counter has not exceeded the maximum value of the anti-replay counter, the HAEE 408 may transmit an indication that the anti-replay counter has not been exceeded 420 to the BPEE 406. In response to the indication that the anti-replay counter has not been exceeded 420, the BPEE 406 may send a request for biometric authentication information 422 to the sensor 402. In response to the request for biometric authentication information 422, the sensor 402 may sample the environment around the sensor to obtain biometric information 424 in a manner substantially similar to that described above with respect to FIG. 3. The sensor 402 may send the obtained biometric information 426 to the BPEE 406. Based on the received biometric information 426, the BPEE 406 may send an indication that biometric information was received 428 to the HAEE 408. In response to the indication that biometric information was received 428, the HAEE 408 may increment the anti-replay counter and initialize a template number 430. The template number tracks which template i, of the n templates stored, is being processed. In some cases, the HAEE 408 may send an acknowledgement 432 (e.g., ACK) of the indication that biometric information was received 428 to the BPEE 406.

In some cases, the BPEE 406 may loop 434 until the number of templates n is reached, a maximum timer value is exceeded, or a template is matched. Within loop 434, the BPEE 406 may transmit a request 436 to the HAEE 408 for a mask corresponding to template i and to decrypt template i. Based on the request 436, the HAEE 408 may, at process 438, increment the anti-replay counter, retrieve the mask value associated with masked template i (e.g., mask i) and encrypt the mask value. For example, the HAEE 408 may have an encryption key that is shared with the BPEE 406 (e.g., during a registration process) and the HAEE 408 may encrypt the mask i using the shared encryption key. The HAEE 408, at process 438, may also decrypt the masked template i stored in the storage accessible to the BPEE 406 (e.g., stored 328 of FIG. 3 during enrollment). The HAEE 408, at process 438, may start a timer during an initial iteration of loop 434. The timer may count until the maximum timer value is reached and/or exceeded, after when the biometric authentication operation may be stopped. In some cases, the timer may be used to avoid brute force, flood attacks, or to determine if the BPEE 406 is responding slower than expected. The HAEE 408 may transmit a response 440 to the BPEE 406. The response 440 may include the encrypted mask i along with a memory address of the masked template i. In some cases, the HAEE 408 may manage both the anti-replay counter and the timer, rather than the BPEE 406.

The BPEE 406 may receive the response 440 and the BPEE 406 may process 442 the encrypted mask i in the response 440, for example, by decrypting the encrypted mask i using the shared encryption key. The BPEE 406 may then mask the obtained biometric information using the decrypted mask i and compare (e.g., match) the masked biometric information to the decrypted masked template i using the memory address in the response 440. In some cases, the BPEE 406 may compare the obtained biometric information for authentication with the template as the HAEE 408 may not have enough computing resources to perform the comparison. Of note, as the biometric information is masked and compared to the masked template, the template is not used in the clear and is encrypted at rest.

In cases where the masked biometric information does not match the decrypted masked template i, the BPEE 406 may delete the decrypted mask i and the decrypted masked template i. The BPEE 406 may also indicate 444 to the HAEE 408 that the comparison was not successful (e.g., NOK) and the loop 434 may may continue with a request for a next mask corresponding to template i+1 similar to request 436.

In cases where the masked biometric information does match the decrypted masked template i, the BPEE 406 may indicate 446 to the HAEE 408 that the comparison was successful (e.g., OK). In response to the indication 446, the HAEE 408 may reset 448 the timer and reset the anti-replay counter. The HAEE 408 may then send an indication that the authentication completed 450 successfully to the BPEE 406, and the BPEE 406 may indicate 452 to the REE 404 that the authentication completed successfully.

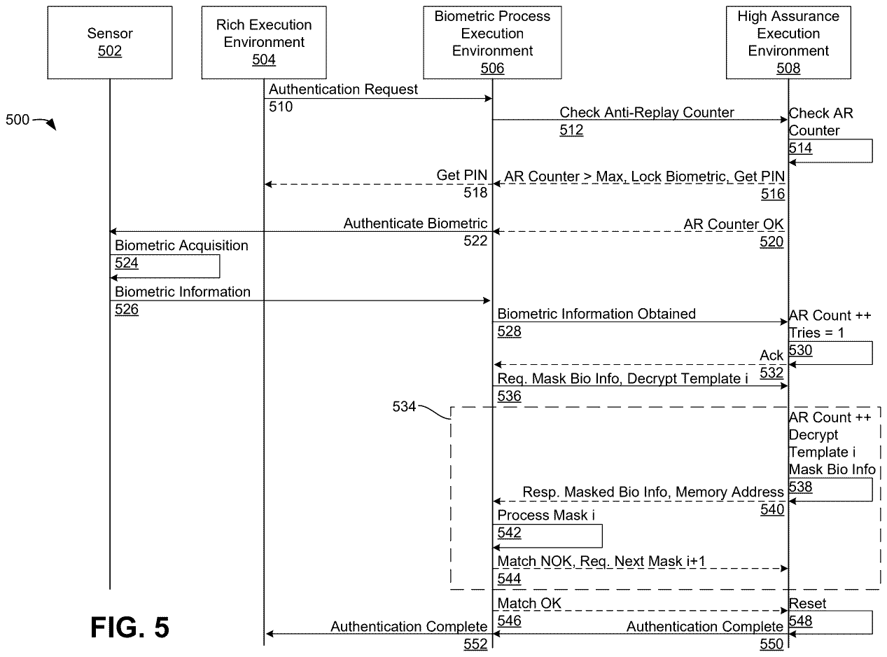

FIG. 5 is a diagram illustrating signals and operations 500 for biometric authentication using another high assurance protected biometric flow, in accordance with aspects of the present disclosure. FIG. 5 is similar to FIG. 4 and FIG. 5 includes a sensor 502, an REE 504, a BPEE 506, and a HAEE 508. In some cases, the sensor 502, REE 504, BPEE 506, and HAEE 508 may be substantially similar to sensor 302, REE 304, BPEE 306, and HAEE 308 of FIG. 3, respectively. The REE 504 may transmit an authentication request 510 to perform biometric authentication to the BPEE 506 and the BPEE 506 may request a check of the anti-replay counter 512 to the HAEE 508 in a manner substantially similar to that discussed above with respect to FIG. 4. The HAEE 508 may check the anti-replay counter 514 and either transmit a PIN request 516 or an indication that the anti-replay counter has not been exceeded 520 to the BPEE 506 in a manner substantially similar to that discussed above with respect to FIG. 4. The BPEE 506 may send a request for biometric authentication information 522 and the sensor 502 may obtain biometric information 524 and send the obtained biometric information 526 to the BPEE 506 in a manner substantially similar to that discussed above with respect to FIG. 4. The BPEE 506 may send an indication that biometric information was received 528, the HAEE 508 may increment the anti-replay counter and initialize a template number 530, and the HAEE 508 may send an acknowledgement 532 in a manner substantially similar to that discussed above with respect to FIG. 4.

In some cases, the BPEE 506 may loop 534 in a manner substantially similar to that discussed above with respect to FIG. 4. Within loop 534, the BPEE 506 may transmit a request 536 to the HAEE 408 to mask the received 528 biometric information using a mask corresponding to template i and to decrypt template i. The request 536 may include the received 528 biometric information. Based on the request 536, the HAEE 508 may, at process 538, increment the anti-replay counter. The HAEE 508, at process 538, may also retrieve the mask value associated with masked template i (e.g., mask i) and mask the biometric information from the request 536. The HAEE 508, at process 538, may also decrypt the masked template i and start a timer during an initial iteration of loop 534 in a manner substantially similar to that discussed above with respect to FIG. 4. The HAEE 508 may transmit a response 540 to the BPEE 506. The response 540 may include the masked biometric information based on mask i along with a memory address of the masked template i.

The BPEE 506 may receive the response 540 and the BPEE 506 may process 542 the masked biometric information in the response 540, for example, by comparing the masked biometric information to the decrypted masked template i using the memory address in the response 540.

In cases where the masked biometric information does not match the decrypted masked template i, the BPEE 506 may delete the masked biometric information and decrypted masked template i. The BPEE 506 may also indicate 544 to the HAEE 508 that the comparison was not successful (e.g., NOK) and the loop 534 may continue with a request for a next mask corresponding to template i+1 similar to request 536.

In cases where the masked biometric information does match the decrypted masked template i, the BPEE 506 may indicate 546 to the HAEE 508 that the comparison was successful (e.g., OK). In response to the indication 546, the HAEE 508 may reset 548 the timer and reset the anti-replay counter. The HAEE 508 may then send an indication that the authentication completed 550 successfully to the BPEE 506, and the BPEE 506 may indicate 552 to the REE 504 that the authentication completed successfully.

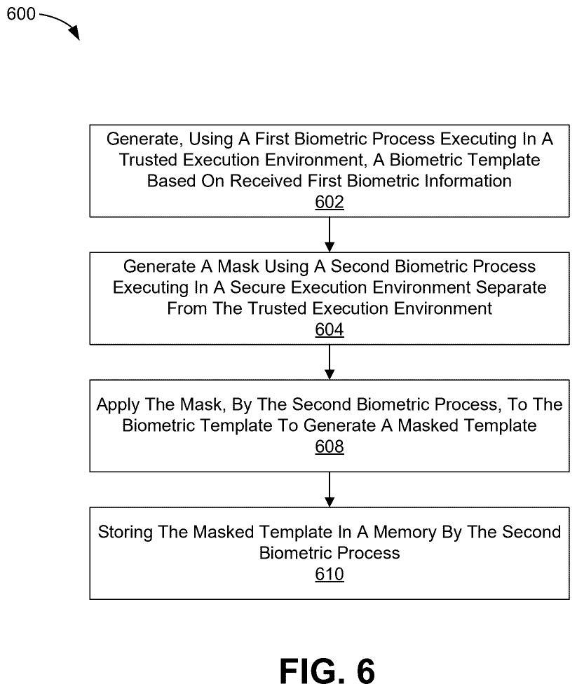

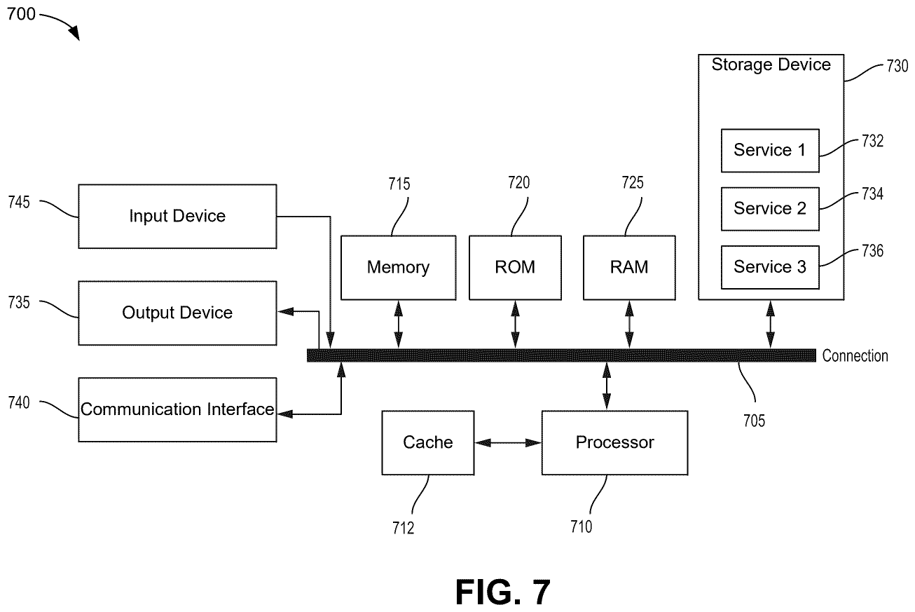

FIG. 6 is a flow diagram of a process 600 for biometric security, in accordance with aspects of the present disclosure. The process 600 may be performed by a computing device (or apparatus) or a component (e.g., a chipset, codec, processor 110 of FIG. 1, TEE 180 of FIG. 1, secure element 190 of FIG. 1, REE 304 of FIG. 3, BPEE 306 of FIG. 3, HAEE 308 of FIG. 3, REE 404 of FIG. 4, BPEE 406 of FIG. 4, HAEE 408 of FIG. 4, REE 504 of FIG. 5, BPEE 506 of FIG. 5, HAEE 508 of FIG. 5, processor 710 of FIG. 7, etc.) of the computing device. Examples of the computing device can include the wireless device 100 of FIG. 1, computing system 700 of FIG. 7. The computing device may be a mobile device (e.g., a mobile phone), an extended reality (XR) device such as a virtual reality (VR) device or augmented reality (AR) device, a vehicle or component or system of a vehicle, a network-connected wearable such as a watch, or other type of computing device. In another example, the process 600 may be performed by a computing device with the computing system 700 shown in FIG. 7. The operations of the process 600 may be implemented as software components that are executed and run on one or more processors. In some cases, the computing device may include an indication, such as a configuration, that the UE may use an enhanced privacy technique, such as techniques discussed in accordance with aspects of the present disclosure.

At block 602, the computing device (or component thereof) may generate, using a first biometric process (e.g., BPEE 306 of FIG. 3, BPEE 406 of FIG. 4, BPEE 506 of FIG. 5, etc.) executing in a trusted execution environment (e.g., TEE 180 of FIG. 1), a biometric template based on received first biometric information. In some cases, the first biometric information may be received from a biometric sensor, such as sensor 302 of FIG. 3, sensor 402 of FIG. 4, sensor 502 of FIG. 5, etc. In some examples, the computing device (or component thereof) may receive, from a process executing in a rich execution environment (e.g., REE 304 of FIG. 3, REE 404 of FIG. 4, REE 504 of FIG. 5, etc.), an indication to enroll biometric information (e.g., enrollment request 310 of FIG. 3). In some cases, the computing device (or component thereof) may generate a request to obtain biometric information (e.g., enroll biometric request 312 of FIG. 3) based on the indication to enroll.

At block 604, the computing device (or component thereof) may generate a mask using a second biometric process (e.g., HAEE 308 of FIG. 3, HAEE 408 of FIG. 4, HAEE 508 of FIG. 5, etc.) executing in a secure execution environment (e.g., secure element 190 of FIG. 1) separate from the trusted execution environment.

At block 606, the computing device (or component thereof) may apply the mask, by the second biometric process, to the biometric template to generate a masked template. In some cases, the computing device (or component thereof) may encrypt, by the second biometric process, the masked template to obtain an encrypted masked template. In some examples, the computing device (or component thereof) may store the encrypted masked template in a protected storage of the memory system accessible to the first biometric process. In some cases, the computing device (or component thereof) may apply the mask to the biometric template by applying an involutive function to the biometric template with the mask. In some examples, the involutive function comprises an exclusive or (XOR) function.

At block 610, the computing device (or component thereof) may store (e.g., stored 328 as shown in FIG. 3) the masked template in the memory system by the second biometric process. In some cases, the computing device (or component thereof) may receive, from process executing in a rich execution environment, an indication to perform biometric authentication (e.g., authentication request 410 of FIG. 4, authentication request 510 of FIG. 5); obtain a masked second biometric information (e.g., process 442 of FIG. 4, response 540 of FIG. 5, etc.) based on received second biometric information (e.g., obtained biometric information 426 of FIG. 4, obtained biometric information 526 of FIG. 5, etc.); and compare the masked second biometric information to the masked template stored in the memory system (e.g., process 442 of FIG. 4, process 542 of FIG. 5). In some examples, the computing device (or component thereof) may transmit, by the first biometric process, a request for the masked template to the second biometric process (e.g., request 436 of FIG. 4, request 536 of FIG. 5, etc.); and receive a memory address corresponding to the masked template stored in the memory system (e.g., response 440 of FIG. 4, response 540 of FIG. 5, etc.). In some examples, the computing device (or component thereof) may obtain the masked second biometric information by transmitting, by the first biometric process, a request for the mask to the second biometric process (e.g., request 436 of FIG. 4); receive, from the second biometric process, the mask (e.g., response 440 of FIG. 4); and apply (e.g., process 442 of FIG. 4) the mask to the second biometric information to obtain masked second biometric information. In some cases, the masked template stored in the memory system is encrypted. In some examples, the mask is encrypted. In some cases, the computing device (or component thereof) may decrypt (e.g., at process 438), by the second biometric process, the masked template stored in the memory system; and apply, by the first biometric process, the mask (e.g., process 442 of FIG. 4).

In some examples, the computing device (or component thereof) may obtain the masked second biometric information by transmitting, by the first biometric process, a request (e.g., request 536 of FIG. 5) to mask (e.g., at process 538) the received second biometric information along with the second biometric information (e.g., request 536 of FIG. 5) to the second biometric process; mask, by the second biometric process, the second biometric information to generate the masked second biometric information; and transmit, by the second biometric process, the masked second biometric information (e.g., response 540 of FIG. 5) to the first biometric process.

In some cases, the computing device (or component thereof) may verify (e.g., check of the anti-replay counter 412 of FIG. 4, check of the anti-replay counter 512 of FIG. 5, etc.), with the second biometric process, that a maximum value for an anti-replay counter has not been exceeded; and increment, by the second biometric process, the anti-replay counter based on the request for the masked template. In some examples, the computing device (or component thereof) may delete the obtained masked second biometric information.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 600 and/or other processes described herein may include a processor, microprocessor, micro-computer, or other component of a device that is configured to carry out the steps of the process 600 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 600 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 600 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 600 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a signal connection into processor 710, such as in a chipset architecture. Connection 705 may also be a virtual connection, networked connection, or logical connection.

In some embodiments, computing system 700 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 700 includes at least one processing unit (CPU or processor) 710 and connection 705 that communicatively couples various system components including system memory 715, such as read-only memory (ROM) 720 and random access memory (RAM) 725 to processor 710. Computing system 700 may include a cache 712 of high-speed memory connected directly with, in close proximity to, or integrated as part of processor 710.

Processor 710 may include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be one or more non-volatile and/or non-transitory and/or computer-readable memory devices and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 730 may include software services, servers, services, etc., that when the code that defines such software is executed by the processor 710, it causes the system to perform a function. In some embodiments, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise one or more of any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 615, read-only memory (ROM) 620, random access memory (RAM) 625, storage device 630, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for biometric security, comprising: a memory system comprising instructions; and a processor system coupled to the memory system, wherein the processor system is configured to: generate, using a first biometric process executing in a trusted execution environment, a biometric template based on received first biometric information; generate a mask using a second biometric process executing in a secure execution environment separate from the trusted execution environment; apply the mask, by the second biometric process, to the biometric template to generate a masked template; and store the masked template in the memory system by the second biometric process.

Aspect 2. The apparatus of Aspect 1, wherein the processor system is further configured to: encrypt, by the second biometric process, the masked template to obtain an encrypted masked template; and store the encrypted masked template in a protected storage of the memory system accessible to the first biometric process.

Aspect 3. The apparatus of any of Aspects 1-2, wherein, to apply the mask to the biometric template, the processor system is configured to apply an involutive function to the biometric template with the mask.

Aspect 4. The apparatus of Aspect 3, wherein the involutive function comprises an exclusive or (XOR) function.

Aspect 5. The apparatus of any of Aspects 1-4, wherein the processor system is further configured to: receive, from a process executing in a rich execution environment, an indication to enroll biometric information; and generate a request to obtain biometric information based on the indication to enroll.

Aspect 6. The apparatus of any of Aspects 1-5, wherein the processor system is further configured to: receive, from process executing in a rich execution environment, an indication to perform biometric authentication; obtain masked second biometric information based on received second biometric information; and compare the masked second biometric information to the masked template stored in the memory system.

Aspect 7. The apparatus of Aspect 6, wherein, to obtain the masked second biometric information, the processor system is further configured to: transmit, by the first biometric process, a request for the mask to the second biometric process; receive, from the second biometric process, the mask; and apply the mask to the second biometric information to obtain the masked second biometric information.

Aspect 8. The apparatus of Aspect 7, wherein the masked template stored in the memory system is encrypted, wherein the mask is encrypted, and wherein the processor system is further configured to: decrypt, by the second biometric process, the masked template stored in the memory system; and apply, by the first biometric process, the mask.

Aspect 9. The apparatus of any of Aspects 6, wherein, to obtain the masked second biometric information, the processor system is further configured to: transmit, by the first biometric process, a request to mask the received second biometric information along with the second biometric information to the second biometric process; mask, by the second biometric process, the second biometric information to generate the masked second biometric information; and transmit, by the second biometric process, the masked second biometric information to the first biometric process.

Aspect 10. The apparatus of Aspect 6-8, wherein the processor system is further configured to: transmit, by the first biometric process, a request for the masked template to the second biometric process; and receive a memory address corresponding to the masked template stored in the memory system.

Aspect 11. The apparatus of Aspect 10, wherein the processor system is further configured to: verify, with the second biometric process, that a maximum value for an anti-replay counter has not been exceeded; and increment, by the second biometric process, the anti-replay counter based on the request for the masked template.

Aspect 12. The apparatus of any of Aspects 6-11, wherein the processor system is further configured to delete the obtained masked second biometric information.

Aspect 13. A method for biometric security comprising: generating, using a first biometric process executing in a trusted execution environment, a biometric template based on received first biometric information; generating a mask using a second biometric process executing in a secure execution environment separate from the trusted execution environment; applying the mask, by the second biometric process, to the biometric template to generate a masked template; and storing the masked template in a memory by the second biometric process.

Aspect 14. The method of Aspect 13, further comprising: encrypting, by the second biometric process, the masked template to obtain an encrypted masked template; and storing the encrypted masked template in a protected storage of the memory accessible to the first biometric process.

Aspect 15. The method of any of Aspects 13-14, wherein applying the mask to the biometric template by applying an involutive function to the biometric template with the mask.

Aspect 16. The method of Aspect 15, wherein the involutive function comprises an exclusive or (XOR) function.

Aspect 17. The method of any of Aspects 13-16, further comprising: receiving, from a process executing in a rich execution environment, an indication to enroll biometric information; and generating a request to obtain biometric information based on the indication to enroll.

Aspect 18. The method of any of Aspects 13-17, further comprising: receiving, from process executing in a rich execution environment, an indication to perform biometric authentication; obtaining masked second biometric information based on received second biometric information; and comparing the masked second biometric information to the masked template stored in the memory.

Aspect 19. The method of Aspect 18, wherein obtaining the masked second biometric information comprises: transmitting, by the first biometric process, a request for the mask to the second biometric process; receiving, from the second biometric process, the mask; and applying the mask to the second biometric information to obtain the masked second biometric information.

Aspect 20. The method of Aspect 19, wherein the masked template stored in the memory is encrypted, wherein the mask is encrypted, and further comprising: decrypting, by the second biometric process, the masked template stored in the memory; and apply, by the first biometric process, the mask.

Aspect 21. The method of any of Aspects 18, wherein obtaining the masked second biometric information comprises: transmitting, by the first biometric process, a request to mask the received second biometric information along with the second biometric information to the second biometric process; masking, by the second biometric process, the second biometric information to generate the masked second biometric information; and transmitting, by the second biometric process, the masked second biometric information to the first biometric process.

Aspect 22. The method of Aspect 18-21, further comprising: transmitting, by the first biometric process, a request for the masked template to the second biometric process; and receiving a memory address corresponding to the masked template stored in the memory.

Aspect 23. The method of Aspect 22, further comprising: verifying, with the second biometric process, that a maximum value for an anti-replay counter has not been exceeded; and incrementing, by the second biometric process, the anti-replay counter based on the request for the masked template.

Aspect 24. The method of any of Aspects 18-23, further comprising deleting the obtained masked second biometric information.

Aspect 25. A non-transitory computer-readable medium having stored thereon instructions that, when executed by at least one processor, cause the at least one processor to perform operations according to any of Aspects 13-24.

Aspect 26. An apparatus for biometric security, comprising one or more means for performing operations according to any of Aspects 13-24.

What is claimed is:

1. An apparatus for biometric security, comprising:
a memory system comprising instructions; and
a processor system coupled to the memory system, wherein the processor system is configured to:
generate, using a first biometric process executing in a trusted execution environment, a biometric template based on received first biometric information;
generate a mask using a second biometric process executing in a secure execution environment separate from the trusted execution environment;
apply, by the second biometric process, the mask to the biometric template to generate a masked template; and
storing the masked template in the memory system by the second biometric process.

2. The apparatus of claim 1, wherein the processor system is further configured to:
encrypt, by the second biometric process, the masked template to obtain an encrypted masked template; and
store the encrypted masked template in a protected storage of the memory system accessible to the first biometric process.

3. The apparatus of claim 1, wherein, to apply the mask to the biometric template, the processor system is configured to apply an involutive function to the biometric template with the mask.

4. The apparatus of claim 3, wherein the involutive function comprises an exclusive or (XOR) function.

5. The apparatus of claim 1, wherein the processor system is further configured to:
receive, from a process executing in a rich execution environment, an indication to enroll biometric information; and
generate a request to obtain biometric information based on the indication to enroll.

6. The apparatus of claim 1, wherein the processor system is further configured to:
receive, from process executing in a rich execution environment, an indication to perform biometric authentication;
obtain masked second biometric information based on received second biometric information; and
compare the masked second biometric information to the masked template stored in the memory system.

7. The apparatus of claim 6, wherein, to obtain the masked second biometric information, the processor system is further configured to:
transmit, by the first biometric process, a request for the mask to the second biometric process;
receive, from the second biometric process, the mask; and
apply the mask to the second biometric information to obtain the masked second biometric information.

8. The apparatus of claim 7, wherein the masked template stored in the memory system is encrypted, wherein the mask is encrypted, and wherein the processor system is further configured to:
decrypt, by the second biometric process, the masked template stored in the memory system; and
apply, by the first biometric process, the mask.

9. The apparatus of claim 6, wherein, to obtain the masked second biometric information, the processor system is further configured to:
transmit, by the first biometric process, a request to mask the received second biometric information along with the second biometric information to the second biometric process;
mask, by the second biometric process, the second biometric information to generate the masked second biometric information; and
transmit, by the second biometric process, the masked second biometric information to the first biometric process.

10. The apparatus of claim 6, wherein the processor system is further configured to:
transmit, by the first biometric process, a request for the masked template to the second biometric process; and
receive a memory address corresponding to the masked template stored in the memory system.

11. The apparatus of claim 10, wherein the processor system is further configured to:
verify, with the second biometric process, that a maximum value for an anti-replay counter has not been exceeded; and
increment, by the second biometric process, the anti-replay counter based on the request for the masked template.

12. The apparatus of claim 6, wherein the processor system is further configured to delete the obtained masked second biometric information.

13. A method for biometric security comprising:
generating, using a first biometric process executing in a trusted execution environment, a biometric template based on received first biometric information;
generating a mask using a second biometric process executing in a secure execution environment separate from the trusted execution environment;
applying the mask, by the second biometric process, to the biometric template to generate a masked template; and
storing the masked template in a memory by the second biometric process.

14. The method of claim 13, further comprising:
encrypting, by the second biometric process, the masked template to obtain an encrypted masked template; and
storing the encrypted masked template in a protected storage of the memory accessible to the first biometric process.

15. The method of claim 13, wherein applying the mask to the biometric template by applying an involutive function to the biometric template with the mask.

16. The method of claim 15, wherein the involutive function comprises an exclusive or (XOR) function.

17. The method of claim 13, further comprising:
receiving, from a process executing in a rich execution environment, an indication to enroll biometric information; and
generating a request to obtain biometric information based on the indication to enroll.

18. The method of claim 13, further comprising:
receiving, from process executing in a rich execution environment, an indication to perform biometric authentication;
obtaining masked second biometric information based on received second biometric information; and
comparing the masked second biometric information to the masked template stored in the memory.

19. The method of claim 18, wherein obtaining the masked second biometric information comprises:
transmitting, by the first biometric process, a request for the mask to the second biometric process;
receiving, from the second biometric process, the mask; and
applying the mask to the second biometric information to obtain the masked second biometric information.

20. The method of claim 19, wherein the masked template stored in the memory is encrypted, wherein the mask is encrypted, and further comprising:
decrypting, by the second biometric process, the masked template stored in the memory; and
apply, by the first biometric process, the mask.
